(19) United States
(12) Patent Application Publication
(10) Pub. No.: US 2009/0180214 A1
(43) Pub. Date: Jul. 16, 2009

(54) TAPE CARTRIDGE WITH BUILT-IN REEL MOTORS

(76) Inventor: Erik Solhjell, Oslo (NO)

Correspondence Address: SCHIFF HARDIN, LLP;PATENT DEPARTMENT, 6600 SEARS TOWER, CHICAGO, IL, 60606-6473, US

(21) Appl. No.: 11/972,308

(22) Filed: Jan. 10, 2008

(51) Int. Cl. G11B 23/02

(52) U.S. Cl. 360/96.1; 360/132

(57) ABSTRACT

A tape cassette has a cassette housing with first and second tape reels retaining tape mounted inside the housing. First and second electric motors are also mounted within the cassette housing respectively driving the first and second reels.

### BACKGROUND

The need for storing all types of information in a digital form is increasing very rapidly. Such information can be all kinds of computer based/generated data, data generated by document scanners, loggers, various form of video or audio, or a combination of all these.

Traditionally, computers are using magnetic hard disks to store such information which is required almost immediately (short retrieval time), while tape is used extensively for backup of such hard disks and also for long time archival storage.

Originally, tape drives were based upon the open-reel principle: The tape to be recorded was supplied on one reel which was mounted on the tape drive by the operator. The tape was then guided from the supply reel across the recording head to an empty take-up reel. As the tape drive was running, more and more tape was moved from the supply reel to the take up reel. At the end, the tape was rewound from the take up reel back on to the supply reel. Then the operator could remove the supply reel and replace it with another one.

This open-reel system is basically completely abandoned today, due to the requirement for skilled operators, the physical size of the supply reel (normally 10 inches or more in diameter), and the fact that there is no protection of the tape when the supply reel is removed from the tape drive. Instead, manufacturers and users have turned to various forms of tape cartridges/cassettes where the tape is stored inside a protective housing.

There are many tape cassette/cartridges in use today; however, they can typically be categorised into two different main groups: 1) single reel cartridge; and 2) dual reel cassette/ cartridge.

The single reel cartridge is really a refined version of the original open-reel system. Well known examples of the single reel cartridge, are the IBM 3480 (later enhanced into 3490 and newer models), the DLT cartridge, the SDLT cartridge (closely related to the DLT cartridge) and the LTO cartridge introduced in year 2000. All these cartridges are characterized by having a square housing (normally either quadratic with roughly 4″×4″ outside base dimensions (DLT, SDLT and LTO) or a square base with 4″×5″ dimensions (3480, 3590)) containing just one single reel of tape. During operation, the cartridge is inserted into the drive and one end of the tape is then automatically pulled out of the cartridge and onto a take up reel inside the drive. Thereafter, the tape is moving between this take up reel and the reel inside the tape cartridge until all the required read or write operations have been completed. Then all the tape is wound back onto the reel inside the tape cartridge and the cartridge can be removed from the drive. The operation therefore resembles the old open reel system, except that the tape cartridge is physically smaller, and is designed so that loading and tape extraction can be done without operator involvement. When inside the cartridge, the tape itself is also protected from direct exposure to human hand and dust.

These single reel cartridges are characterized by having a “door” in connection with one of their sidewalls. This “door” will swing or slide open after the cartridge has been inserted into the tape drive to allow the end of the tape to be pulled out and moved by the tape drive mechanism over to the take up reel inside the drive.

When the tape cartridge is inserted into the drive, a motor in the drive engages with a driving plate at the bottom of the cartridge. The driving plate is connected with the tape reel inside the cartridge to allow the drive full control over the tape movements.

These single reel cartridges have increased in popularity during the last few years, because they offer relatively large tape length in a relatively small cartridge housing. Also, the cost of building tape drives which can handle such cartridges effectively and reliably has gone down considerably. In addition, a large number of automation systems are now offered which can handle a volume of such cartridges and the corresponding tape drive operations completely automatically.

Various form of single reel cartridges are now dominating the mid-range to high end of the professional data tape backup market, effectively making this cartridge technology the mainstream technology in these market segments.

Nevertheless, single reel tape cartridges have some basic drawbacks. The most important one is that the tape always needs to be pulled out of the cartridge onto the take up reel inside the drive. This requires a fairly sophisticated and complex drive mechanism, and it takes time. Many single reel cartridge systems needs between 20 and 60 seconds or more just to load the tape properly. This will significantly reduce the effective speed of the system (longer data access time).

Furthermore, if power is lost during operation, it is normally very difficult or even impossible to eject the cartridge from the tape drive. For some applications and systems, this may be a severe drawback.

The dual reel cartridge is well known in many different versions: 4 mm DAT or DDS cartridge, 8 mm videocassette, the 3M QIC (SLR) cartridge, the Philips audio (Compact) cassette and the VHS video cassette just to name a few.

The principle of the dual reel cartridge is that both tape reels are located within the cartridge housing. The tape moves from one reel to the other during operations. A portion of the tape housing is typically designed to be opened when the cartridge is inserted into the tape drive. The tape cassette can then be moved to allow the tape to get in contact with the drive read/write head, the tape capstan spindle(s) and the drive tape guides. Dual reel cartridges have two openings at the bottom where suitable motors in the tape drive can engage to the tape reels inside the cartridge to run the tape reels. In some cases, like the VHS, the 8 mm and the 4 mm DAT cassettes, a section of the tape is also actually pulled out of the cassette during insertion into the drive and wrapped around the recording heads and over the drive tape guides.

Compared with the single reel cartridge design, the dual reel cassette/cartridge normally makes it possible to design drives that mechanically are less complex than drives designed for single reel cartridges. However, the drive still need motor(s) to drive the tape hubs and in some cases also a motor to partly pull out the tape from the cassette opening. Also, it is normally impossible to easily remove the tape cartridge in case power is lost while portion of the tape is outside the VHS, 4 mm DAT, 8 mm or similar cartridges,

A general drawback with dual reel cassettes/cartridges is that for the same given cartridge housing size, the dual reel cartridge will contain a shorter length of tape than the single reel version can do with the same housing dimensions.

For many years, video cassettes based upon dual reel designs like the VHS cassette, enjoyed a very high popularity world wide for all types of consumer video storage. The dual reel cartridge has also become quite popular in the lower end of the data tape drive market, especially because the mechanical design of the tape drive can be made simpler and some times more reliable than for drives utilizing single reel cartridges.

While VHS cassettes are still used for video storage, most customers have now turned to integrated hard disks to temporarily store video information and then either delete the stored information or copy it to rewritable optical disks, DVDs, in order to store it more permanently. A problem however, is that these optical disks have fairly limited capacity (currently in the range of 4 to 25 GBytes). Since downloading film and programs over the internet as well as high definition TV rapidly is becoming popular in many parts of the world, consumers will be looking for better and more effective ways to permanently store very large quantities of recorded video information. New TVs and Set-Top boxes will be equipped with hard disk drives that probably in a few years will offer capacities in the order of 1 TB (Terabyte) or more. However, a serious problem is that when these hard disks finally are filled up with video contents, the user needs to go through a process of deleting material he or she does not need any longer and then transfer any material he or she wants to keep to another media like an optical disk (typically having far less capacity than the hard disk). Also, many consumers are now creating large numbers of digital pictures or personal digital video every year, and this is also creating a need for high capacity permanent storage. Again, large capacity hard disk drives will normally be used as the primary storage media for this kind of material; however, there exists a need for reliable; low cost, high capacity and removable storage media that can be used for long term archival storage and a backup in the case the hard disk drive fails or its contents is accidentally erased.

During the last years, special hard disk systems where the hard disks are mounted in a cartridge or cassette housings and can be removed from the “drive” has been introduced to the market. These hard disk systems are normally designed to allow the cartridge to be easily removed and inserted and they are also designed so that the disk cartridge itself can tolerate a fair amount of shock. These requirements typically limit the maximum capacity available in each cartridge and they are also relatively expensive. It is also a question how long they may keep their data contents intact during long term archival conditions.

Tape is still the cheapest high capacity media available today, but the complexity and cost of today's advanced tape drives have limited their acceptance among typical end user consumers. While high end tape drives like LTO4 are approaching the Terabyte level and the LTO4 media cost may be acceptable to many users, the initial drive cost of a modern professional tape drive like LTO4 may be too high for these users when they buy a new system.

### SUMMARY

It is an object to bring about a new type of tape cassette or cartridge with features that make it possible to reduce complexity and cost of a tape drive itself quite significantly, while at the same time allowing for a cassette or cartridge design which is robust, user friendly and with a potential for very high capacity storage.

A tape cassette has a cassette housing with first and second tape reels retaining tape mounted inside the housing. First and second electric motors are also mounted within the cassette housing respectively driving the first and second reels.

### BRIEF DESCRIPTION OF THE DRAWINGS

FIG. 1 is a simplified top view illustration with a top of a housing of a tape cassette removed for ease of viewing of a preferred embodiment of the tape cassette having each tape reel driven by a respective electric motor mounted in the cassette;

FIG. 2 is a side cross-sectional view taken along line 2-2 in FIG. 1 of the cassette;

FIG. 3 is a perspective view of the cassette of FIG. 1 showing a rack gear not further illustrated in FIGS. 1 and 2;

FIG. 4 is a top view showing insertion of the cassette of FIG. 1 into a drive where the drive is shown in a simplified cross-section and fragmentary fashion;

FIG. 5 is a side view of the cassette in the drive shown in cross-section and showing electrical contacts to the cassette;

FIG. 6 is a side view of the cassette in the drive shown in cross-section where the drive has a movable read/write head movable up into the cassette through a slot or opening in the cassette;

FIGS. 7A and 7B show a fragmentary cross-section of the cassette and illustrate a method to open up the slot in the cassette to make room for the head to be moved upwards into the cassette;

FIG. 8 shows a side cross-sectional view to illustrate a write/read head embedded inside the cassette and engageable by an exterior head moving system; and

FIG. 9 shows a cassette top view with a top of the cassette housing not present to illustrate that not only the head as shown in FIG. 8 but also a moving system for the head are mounted inside the cassette.

### DESCRIPTION OF THE PREFERRED EMBODIMENTS

For the purposes of promoting an understanding of the principles of the invention, reference will now be made to the preferred embodiment/best mode and other embodiments illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

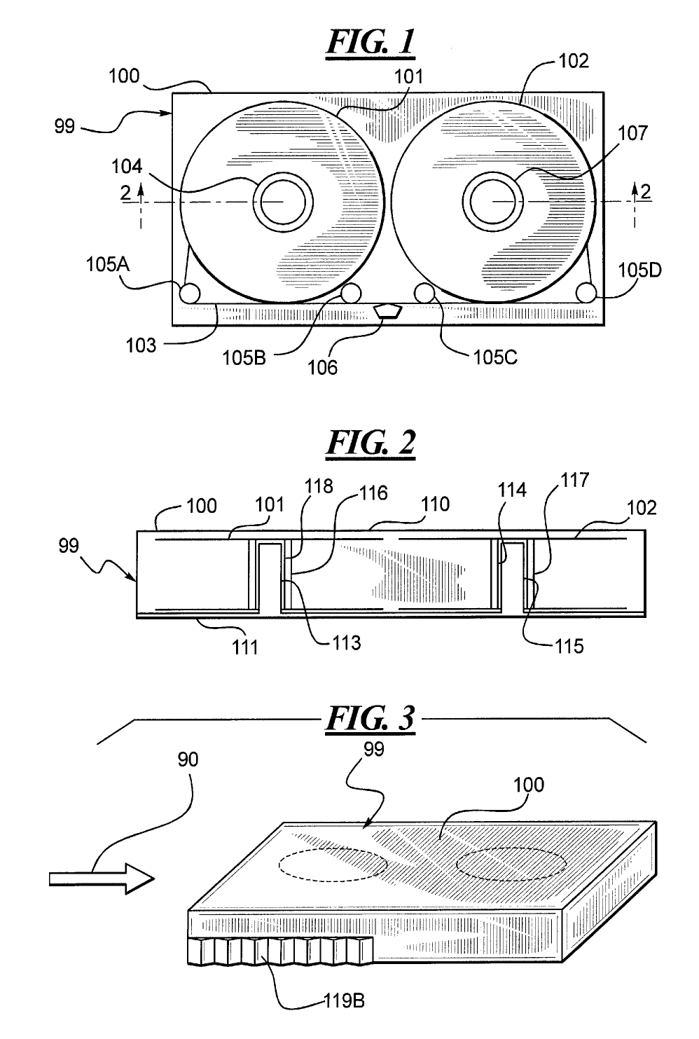

A basic illustration of a preferred embodiment of the new cassette or cartridge is shown in FIGS. 1 and 2 at 99. FIG. 1 shows the cassette 99 seen from above, while FIG. 2 shows the cassette 99 seen from one side. The tape 103 is contained in a cassette housing 100 of the cassette 99 with two tape reels, a left reel 101 and a right reel 102. Each tape reel is driven by a built-in electric motor, a left reel motor 104 and a right reel motor 107, so there is no need for a mechanical contact between the cassette 99 and the tape drive to move the tape reels (and the tape).

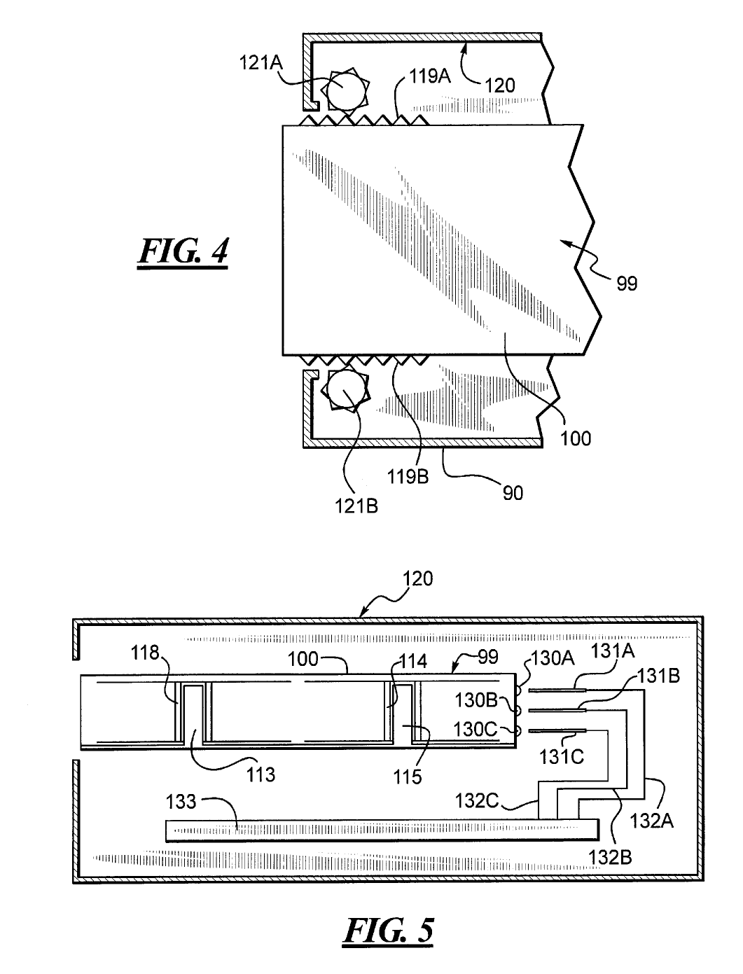

The tape is guided in correct positions by one or more tape guides 105A-D integrated into the cassette housing 100. A read/write tape head 106 performs the read and write operations on the tape. This head may either be a part of the cassette 99 itself or it may be part of the drive and brought in contact with the tape when the cassette 99 is inserted into the tape drive 120 (FIG. 4). The head may be a read head only, a write head only, or a read/write head.

FIG. 2 shows the basic cassette 99 design from the side. For simplicity reasons, no tape, head or tape guides are shown in this figure. Number 110 indicates the upper part of the cassette housing 100, while 113 indicates the lower part. The motors are fixed to the cassette housing (typically the bottom). The motors are of the “outer rotor type”, meaning that the outer shell of the motor is rotating rotor, while the inner core of the motor is steady, such as the motor stator. It is the inner core or stator of the motors that may be fixed to the cassette housing 100. The outer shells or rotors of the motors may be fixed to the center of the tape reels. In FIG. 2, the left reel motor (104 in FIG. 1) has a static inner core 113 fixed to the bottom of the cassette housing 100 and a rotating outer shell 118 fixed to the inner walls 116 of the left reel 101. Likewise, the right motor (105 in FIG. 1) has an inner static core 115 fixed to the cassette housing bottom and a rotating outer core 114 fixed to the inner walls 117 of the right tape reel 102. Therefore, the motion of the tape reels 101 and 102 are controlled by running the motors 104 and 105 respectively.

FIGS. 3 and 4 show the external cassette housing 100 having a rack gear 119A,B on each side of the housing 100. When the tape cassette 99 is inserted by the user into the tape drive 120 (FIG. 4) (in the direction of the arrow 90), cog wheels 121A,B in the drive 120 on each side of the opening for the cassette engage with the respective rack gear 119A,B and move the cartridge further into the drive as shown in FIG. 4.

In FIG. 4, 90 indicates a drive with the two cog wheels 121A,B. When the user inserts the cassette housing 100 into the drive, the cogwheels 121A, B will engage with the rack gears 119A,B. A sensing system (not shown) will then sense that the cassette housing 100 has been inserted so far into the drive 120 that the cog wheels 121A,B can take over the rest of the insertion process. Motors connected to the cog wheels 121A,B then turn these wheels until the cassette has been correctly inserted into the drive.

The cog wheels 121A,B are also active during cassette removal. In this case, the cog wheels 121A,B will turn the opposite way so that the cassette housing with the rack gears 119 are moved out of an opening of the drive 120 until the cassette 99 is so far out that the racks gears 119A,B no longer connect with the cog wheels 121A,B. The user can then take the cassette by hand and pull it completely out of the drive 120.

When the cassette 99 is inserted into the drive 120, electrical contacts 130A,B,C associated with and mounted on the cassette housing 100 contact with contacts 131A,B,C inside the drive 120 in order to connect the motors inside the cassette to the motor control electronics board 133 of the drive 120. See FIG. 5.

In FIG. 5, the cassette with the cassette housing 100 is shown inserted into the drive enclosure portion 90. Contacts 130A,B,C at one end of the cassette housing 100 make electrical contact with correctly positioned contacts 131A,B,C in the drive (to more easily show the concept, the drawing shows the cassette not fully inserted), so there is a short distance between the contacts 130A,B,C on the cassette housing 100 and the contacts 131A,B,C in the drive 120. Contact between the contacts 130A,B,C and the contacts 131A,B,C is made when the cassette is completely inserted into the drive.

The contacts 130A,B,C are connected to the motors 118 and 114 (not shown in FIG. 5). Since the motors have a rotating outer shell and a fixed inner core, the connections will normally be to the motor coil of the inner core.

The cog wheels 121A,B are also active during cassette removal. In this case, the cog wheels 121A,B will turn the opposite way so that the cassette housing with the rack gears 119 are moved out of an opening of the drive 120 until the cassette 99 is so far out that the racks gears 119A,B no longer connect with the cog wheels 121A,B. The user can then take the cassette by hand and pull it completely out of the drive 120.

When the cassette 99 is inserted into the drive 120, electrical contacts 130A,B,C associated with and mounted on the cassette housing 100 contact with contacts 131A,B,C inside the drive 120 in order to connect the motors inside the cassette to the motor control electronics board 133 of the drive 120. See FIG. 5.

In FIG. 5, the cassette with the cassette housing 100 is shown inserted into the drive enclosure portion 90. Contacts 130A,B,C at one end of the cassette housing 100 make electrical contact with correctly positioned contacts 131A,B,C in the drive (to more easily show the concept, the drawing shows the cassette not fully inserted), so there is a short distance between the contacts 130A,B,C on the cassette housing 100 and the contacts 131A,B,C in the drive 120. Contact between the contacts 130A,B,C and the contacts 131A,B,C is made when the cassette is completely inserted into the drive.

The contacts 130A,B,C are connected to the motors 118 and 114 (not shown in FIG. 5). Since the motors have a rotating outer shell and a fixed inner core, the connections will normally be to the motor coil of the inner core.

The signals (comprising an electric power supply) to or from the motors 114 and 118 are fed via the contacts 130A,B,C and 131A,B,C, and cables 132A,B,C, to a drive control board 133. Therefore, the drive 120 can control the tape movement within the cassette 99 as if the tape reel motors where situated in the drive (as it's the normal way for any tape drives today) and not in the cassette.

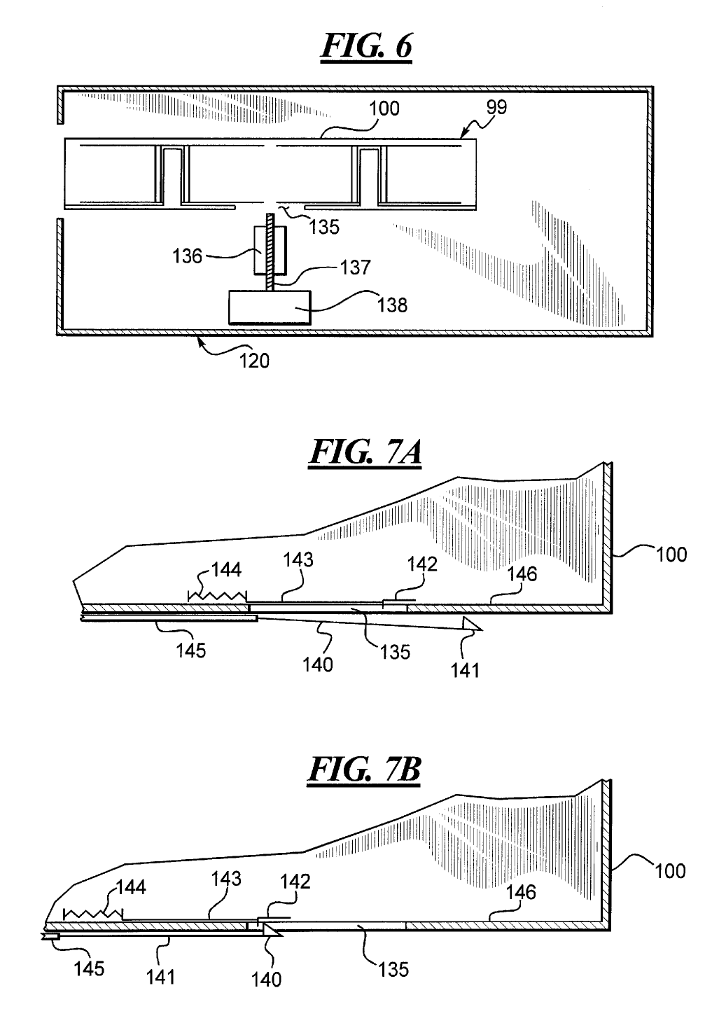

In order to write data information to the tape or read data information from the tape, it is necessary to have a read/write head in contact with the tape. This can be achieved in several different ways. FIG. 6 shows a method whereby the head is situated in the drive 120 below the cassette 99 when the cassette is inserted or removed. When the cassette 99 is inserted into the drive 120, an opening 135 at the bottom of the cassette housing 100 is exposed because a spring loaded cover is pulled back. This cover is not shown in FIG. 6 for viewing clarity but is shown in FIG. 7A and FIG. 7B illustrating construction details thereof.

Once the cassette 99 is fully inserted into the drive 120 and the opening 135 is completely open, the drive can move a read and write head 136 upwards until it engages with the tape inside the cassette 99. This head movement can be achieved in many ways, for example by using a small stepper motor 138 and a screw shaft 137. Rotating the screw shaft 137 by the motor 138 will move the head 136 upwards or downwards depending upon the rotational direction.

The head 136 may either be just a standard magnetic read and write head or it can also be a unit which in addition to the read/write head contains a system for following any servo tracks recorded on the tape. Such a system typically contains a small voice coil to allow the head to be rapidly adjusted upwards or downwards in order to follow the typical variations of the tape position as the tape is running.

FIG. 7A and FIG. 7B show a method to open up a slot in the cassette 99 in order to make room for the head to be moved upwards and into the cassette so it engages with the tape 103. The drawings in FIGS. 7A and 7B shows a portion of the cassette housing 100 with the bottom part 146. In this bottom 146 is an opening 135 which is big enough to allow the head (136 in FIG. 6) to be moved through. When the cassette 99 is outside the drive 120, this opening in the bottom of the cassette is covered by a slider 143. The slider keeps the opening 135 covered due to a spring 144.

When the cassette is inserted in the drive opening and moved inwards into the drive, the cassette bottom 146 slides touches a spring loaded hook 141, forcing this hook downwards. As the cassette is moving further into the drive, the hook 141 engages with a dent 142 in the slider 143 forcing this slider backwards (towards the spring 144 and thereby exposing the opening 135 in the cassette bottom.

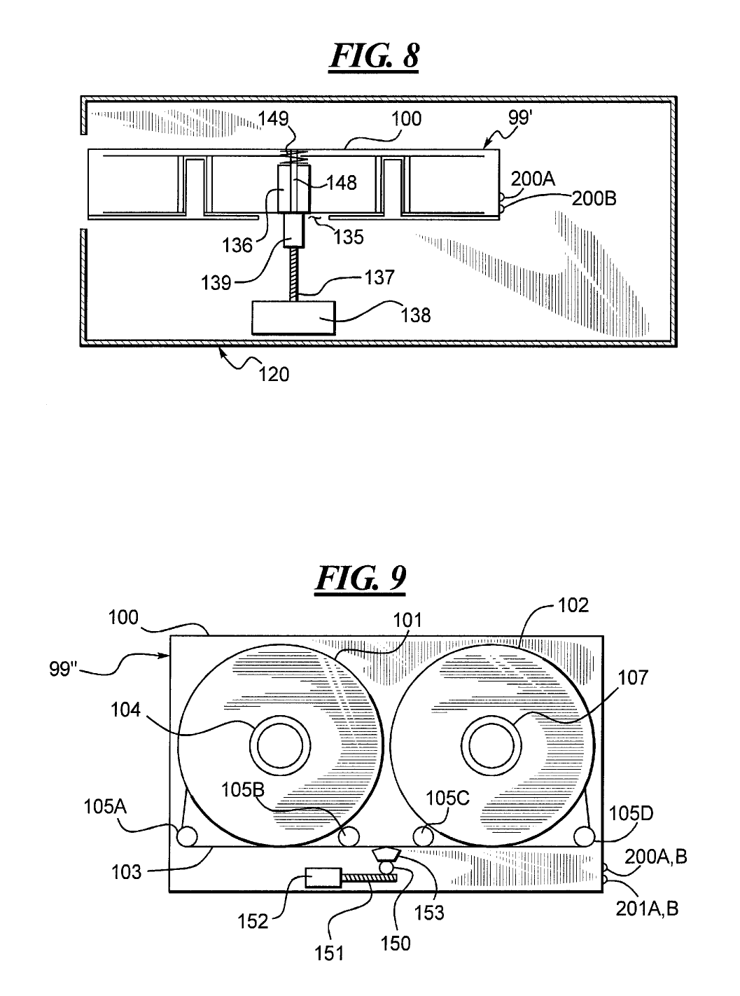

While the system described in FIG. 6 may be the most cost effective for most application, there are also other alternatives that may be desirable for more sophisticated applications. This involves embedding the read/write head inside the cassette as shown in FIG. 8.

In this embodiment, the recording head 136 is permanently placed inside the cassette 99′, with the possibility to slide up and down inside the cassette housing guided by one or more guiding pins 148. A spring 149 is keeping the head pressed downwards towards the bottom of the cartridge. When the cartridge is inserted into the drive and the bottom opening 135 is exposed, a screw motor system comprising a step motor 138 with a screw shaft 137 similar to the one described in FIG. 6. However, instead of having the head 136 mounted on the screw shaft 137, the head movement is now controlled via a small screw knob 139 on the shaft. Rotating the screw shaft 137 in one direction will move the knob 139 upwards, pressing on the head 136 and moving it upwards. Rotating the shaft 137 in the opposite direction will move the knob 139 downwards and the head 136 will also follow downwards, being pressed down by the spring 149.

Contacts such as 200A,B shown in FIG. 8 may be provided for tape head 136 mounted in the cassette housing. Of course the number of contacts indicated is only illustrative and may depend on the type of tape head employed. The motor contacts illustrated in FIG. 5 are not shown in this view for simplicity.

Another embodiment shown in FIG. 9 involves mounting the whole head assembly inside the cassette 99″. In this case, the cassette 99″ can be made without any direct openings, thereby drastically reducing the possibility of contaminations on the tape. The actual implementation of such a self-contained cassette system may vary depending upon the actual recording requirements. One method for the implementation is shown in FIG. 9. In this case, a step motor 152 with a horizontal shaft 151 is driving a vertical shaft 150. This vertical shaft 150 will rotate either way depending upon the rotation of the step motor. The head assembly 153 is connected to the vertical shaft 150 in such a way that when the shaft 150 rotates in one direction, the head assembly 153 moves upwards, and the when the shaft 150 rotates in the opposite direction, the head assembly 153 is moving downwards. The head assembly can consist of just a read or write head; a more sophisticated read and write head with separate channels for reading and writing or it can be a complete assembly which also includes a voice coil to fine tune the head position.

To support the internally mounted tape head and drive system, the contacts 200A,B described in FIG. 8 are also provided on the cassette in FIG. 9. Additional contacts 201A,B, for example, are also provided for control of the tape head step motor 152, for example. The number of contacts shown is only illustrative and different numbers of contacts may be employed.

The implementation of the head moving system shown in FIG. 9 is just one of many ways whereby this head movement can be implemented. For example, another way is to drop the use of a step motor (or a linear motor for that matter) and instead use a piezo-electric system. It is also possible to design a voice coil system which combine the coarse movement of the head from track group to track group with the fine pitch movement of the head needed to follow pre-recorded servo tracks.

Although preferred exemplary embodiments have been shown and described in detail in the drawings and in the preceding specification, these should be viewed as purely exemplary and not as limiting the invention. It is noted that only the preferred exemplary embodiments are presented and described, and all variations and modifications that presently and in the future lie within the protective scope of the invention should be protected.

I claim as my invention:

1. A tape cassette, comprising:
a cassette housing;
first and second tape reels retaining tape and mounted inside the housing; and
first and second electric motors also mounted within the cassette housing respectively driving the first and second reels.

2. A tape cassette of claim 1 wherein the first and second electric motors each comprise an outer rotatable portion attached to the respective reel and an inner non-rotatable portion mounted in fixed relation with respect to the cassette housing.

3. A tape cassette of claim 2 wherein said non-rotatable portion is fixed directly to the cassette housing.

4. A cassette of claim 2 wherein the outer rotatable portion is fixed directly to a center of the respective tape reel.

5. A cassette of claim 2 wherein said outer rotatable portion comprises an outer shell of the motor.

6. A cassette of claim 5 wherein in the outer shell comprises an outer rotor of the motor.

7. A cassette of claim 2 wherein the non-rotatable portion comprises an inner core of the motor.

8. A cassette of claim 7 wherein the inner core comprises a stator of the motor.

9. A cassette of claim 1 wherein the cassette has contacts for interaction with corresponding contacts in a drive receiving the cassette to deliver power to the first and second motors.

10. A cassette of claim 1 wherein an opening is provided in the cassette housing for receiving a tape head mounted in a drive receiving the cassette and movable through the opening to be positioned at the tape of the cassette.

11. A cassette of claim 1 wherein a tape head is mounted in the cassette housing.

12. A cassette of claim 11 wherein an opening is provided in the cassette housing for receiving a tape head movement system of a drive which receives the cassette for moving the head when the cassette is inserted into the drive.

13. A cassette of claim 12 wherein said opening has a movable slider which opens and closes the opening.

14. A cassette of claim 11 wherein in addition to the tape head, a head movement system which moves the head is also mounted in the cassette housing.

15. A cassette of claim 14 wherein said movement system also mounted in said cassette housing comprises a stepper motor connected to a screw shaft engaging with a head mounting shaft which carries said head assembly to move the head across the tape when the mounting shaft rotates.

16. A cassette of claim 11 wherein said tape head mounted in said cassette housing is mounted on a guiding pin.

17. A cassette of claim 1 wherein at least one rack gear is provided at an outer portion of said housing for engaging with a drive wheel for moving the cassette into and out of a drive.

18. A cassette of claim 1 wherein first and second gears are provided at opposite side walls of the cassette housing for engagement with respective first and second drive wheels in a drive for receiving said cassette.

19. A cassette of claim 1 wherein a plurality of guide pins are provided in the housing for guiding the tape between the first and second reels.

20. A cassette of claim 1 wherein said tape comprises digital data storage tape and the cassette comprises a digital data storage cassette.

21. A cassette system, comprising:
a cassette drive which receives a tape cassette, said cassette drive having an opening and a first set of electrical contacts which supply power to the cassette when the cassette is inserted into the device; and
said tape cassette comprising a cassette housing, first and second tape reels retaining tape and mounted inside the housing, first and second electric motors mounted within the cassette housing respectively driving the first and second reels, and a second set of contacts mating with said first set of contacts to deliver said power to said first and second motors.

22. A system of claim 21 wherein the cassette drive has a head movable through an opening in the cassette to be positioned at the tape of the cassette when the cassette is mounted in the drive.

23. A system of claim 21 wherein a tape head is mounted in the cassette housing, and an opening is provided in the cassette housing for receiving a tape head movement system provided in the drive for moving the head when the cassette is inserted into the drive.

24. A system of claim 23 wherein in addition to the tape head, a movement system which moves the head is also mounted within the cassette housing and contacts are also provided at the drive and the cassette to deliver power from the drive to the movement system.

25. A tape cassette, comprising:
a cassette housing;
first and second tape reels retaining tape and mounted inside the housing;
first and second electric motors also mounted within the cassette housing respectively driving the first and second reels; and
contacts on the cassette housing for receiving power for the first and second motors from a drive into which the cassette is to be inserted.

26. A tape cassette according to claim 25 wherein the cassette housing also has a tape head mounted therein and contacts for said tape head.

27. A tape cassette according to claim 25 wherein the cassette housing has an opening allowing access to said tape head for movement of said tape head by a tape head movement system in the drive into which the cassette is to be inserted.

28. A tape cassette according to claim 25 wherein the cassette has both a tape head and a movement system for the tape head therein, and at least one contact for the movement system of the tape head.

29. A method for operating a tape cassette having first and second tape reels mounted inside a housing of the tape cassette, comprising the steps of:
providing first and second motors also mounted within the cassette housing respectively driving the first and second reels when the cassette is inserted into a drive; and
powering the first and second motors by electric power received from the drive via contacts in the drive and corresponding contacts on the tape cassette when the cassette is inserted into the housing.

30. A method of claim 29 including the step of also mounting a tape head in the cassette housing and moving the tape head with a tape head movement system inserted through an opening in the cassette housing to move the tape head.

31. A method of claim 29 wherein both a tape head and a tape head movement mechanism for the tape head are mounted in the cassette housing and receive power from the drive via at least one drive contact and a corresponding at least one contact on the cassette housing.

32. A method of claim 29 wherein the tape comprises digital data tape and the cassette comprises a digital data storage cassette.
